(19) United States
(12) Patent Application Publication
(10) Pub. No.: US 2020/0361681 A1
(43) Pub. Date: Nov. 19, 2020

(54) PACKAGING SUBSTRATE

(71) Applicants: INNOVIA FILMS LTD., Wigton, Cumbria (GB); FOOD FRESHNESS TECHNOLOGY HOLDINGS LTD., London (GB)

(72) Inventors: Caroline ZEYFERT, Wigton, Cumbria (GB); Jonathan HEWITT, Wigton, Cumbria (GB); Jamie MOFFAT, Wigton, Cumbria (GB); Elizabeth TATLOCK, Wigton, Cumbria (GB); Adam EDKINS, London (GB); Lawrence James Davison MATTHEWS, London (GB); Mark PALMER, London (GB)

(21) Appl. No.: 16/961,864

(22) PCT Filed: Feb. 4, 2019
(86) PCT No.: PCT/EP2019/052671

§ 371 Date: Jul. 13, 2020

(30) Foreign Application Priority Data
Feb. 5, 2018 (GB) 1801817.6

(51) Int. Cl. B65D 65/42; C08J 7/04; C09D 133/08; C09D 175/14; C08J 5/18; D21H 19/20; D21H 19/24; D21H 19/22; D21H 27/00; D21H 27/10; B65D 81/26; D06N 3/00

(52) U.S. Cl. CPC B65D 65/42; D06N 2211/20; C09D 133/08; C09D 175/14; C08J 5/18; D21H 19/20; D21H 19/24; D21H 19/22; D21H 27/002; D21H 27/10; B65D 81/263; D06N 3/0063; D06N 3/0011; C08J 2401/08; C08J 2409/06; C08J 2429/04; C08J 2433/08; C08J 2439/06; C08J 2475/14; D06N 2209/165; C08J 7/0427

(57) ABSTRACT

The present invention provides a coating composition comprising a binder, a rheology modifier that acts to increase the viscosity of the coating composition and a particulate component able to remove a volatile organic compound from an environment in contact with the coating composition.

### CROSS-REFERENCE TO RELATED APPLICATIONS

This application is a national stage application of International Patent Application No. PCT/EP2019/052671, filed Feb. 4, 2019, which claims priority to United Kingdom patent Application No. 1801817.6, filed Feb. 5, 2018. The entirety of the aforementioned applications are incorporated herein by reference.

### FIELD

The present invention concerns a coating composition and a substrate for use in or as a packaging structure.

### BACKGROUND

Modification of the environment within a packaging can be very important, particularly when the packaging contains organic matter, such as food products. Organic matter can emit volatile organic compounds (VOCs) such as ethylene or trimethylamine, which can affect the quality of the organic matter itself.

Removal of VOCs from the packaging environment helps to prolong the shelf life and enhance the marketable quality of the organic matter, such as fresh produce and horticultural products, as well as the quality of the matter over time. It can also help to reduce or eliminate unwanted odours and to maintain the colour and/or firmness of the organic matter.

Ethylene acts as a ripening hormone, which can lead to over-ripening of the organic matter in the packaging and thereby reduce its quality, as well as causing yellowing and peel damage. Ethylene is also produced by organic matter as a result of stress and so its removal helps to mitigate the effects of stress on the organic matter. There are currently a number of ways to remove ethylene from a packaging environment, such as ventilation, chemical techniques, adsorption, photocatalytic methods, chemically catalytic methods and scavenging.

A film for use in or as a packaging that removes VOCs from a surrounding environment is disclosed in WO2016181132. The coating on a surface of this film comprises a binder and a particulate protuberant component able to remove a VOC from an environment in contact with the film in the packaging structure.

The film is formed using a flood coating, such as an aqueous flood coating applied by gravure or reverse gravure, slot die coating, extrusion coating or any other coating technique. This ensures that the particulate component protrudes from the surface of the coating. The particles may be exposed or may be covered by a thin layer of coating material. This layer must be sufficiently thin to ensure efficient interaction of the VOC with the particulate components.

The film is formed using a flood coating, such as an aqueous flood coating applied by gravure or reverse gravure, slot die coating, extrusion coating or any other coating technique. This ensures that the particulate component protrudes from the surface of the coating. The particles may be exposed or may be covered by a thin layer of coating material. This layer must be sufficiently thin to ensure efficient interaction of the VOC with the particulate components.

During the manufacture of such films, the particulate components of the coating composition separate from the binder as a sediment. The sedimentation can occur in the feed tank during the film manufacture, which reduces the concentration of the particulate components in the circulating coating composition that is then applied to the film. This reduces the efficiency of VOC removal by the resulting film, as well as meaning that the particles are not uniformly distributed throughout the coating once it has been applied to the surface of the film. Sedimentation may also cause blockages within the machinery used to create the film.

The importance of an even distribution of particles is acknowledged in WO2016181132 and is provided by using flood coating and specific dry weight ratios of the particulate component and the binder component. However, this limits the method of manufacturing the film.

Additionally, as disclosed in the Examples of WO2016181132, the process of manufacturing the films disclosed therein requires the coating composition to be continuously stirred, in order to re-suspend the particulate components evenly. This increases the cost and complexity of the manufacturing process.

WO2018/007798 and GB2538255 disclose a coating comprising a binder and particles of a VOC scavenger, for application onto a substrate.

WO2012089805 discloses a coating containing particles of syndiotactic polystyrene in a polymeric binder.

Thus, there is required a means for ensuring equal distribution of the particulate component throughout the coating composition when applied to a substrate that does not require the use of flood coating, a specific ratio of components or agitation of the coating composition.

### BRIEF DESCRIPTION OF THE DRAWINGS

The invention will now be more particularly described with reference to FIG. 1, in which FIG. 1 illustrates an embodiment of the substrate of the present invention.

FIG. 1 illustrates a substrate 1 comprising a base layer 2 and a coating comprising a mixture of a binder and a rheology modifier 3 and a particulate component 4. The particulate component 4 is anchored to the substrate 1 by the mixture of the binder and rheology modifier 3.

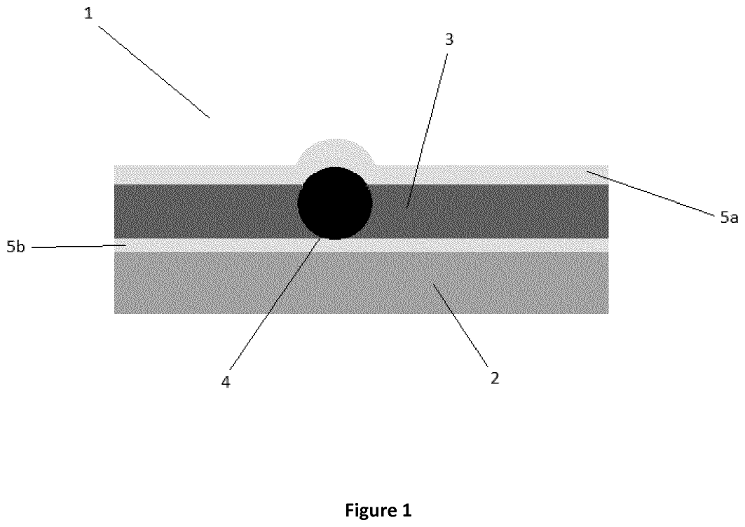

### DETAILED DESCRIPTION

According to a first aspect of the present invention there is provided a coating composition comprising a binder, a rheology modifier that acts to increase the viscosity of the coating composition and a particulate component able to remove a volatile organic compound from an environment in contact with the coating composition.

The binder is the component that acts to attach the coating composition to a substrate. The rheology modifier is the component that increases the viscosity of the coating composition compared to the viscosity of the composition without the rheology modifier present.

It has surprisingly been found that the increased viscosity resulting from the inclusion of a rheology modifier stabilises the dispersion of the particulate component in the coating composition, thereby reducing the rate of sedimentation of the particulate component, either in the presence or absence of agitation. This therefore ensures an equal distribution of the particulate component throughout the coating once the coating composition has been applied to a base layer.

Further, the inclusion of a rheology modifier and the resulting increased viscosity means that alternative methods of applying the coating to a base layer can be used. For example, the increased viscosity means that a printing process rather than a coating process can be used. This allows the coating composition to be used in combination with a broader range of base layers compared to that disclosed in WO2016181132, which only makes use of a film base layer. Thus, the coating composition is preferably printable.

Printing the coating composition allows it to be applied in a particular position on the film in contrast to the edge to edge coverage resulting from a coating process. Printing also means that a particular shape can be applied, which could be combined with artwork or branding. In addition, printing is fast, low cost, widely available and can be combined in-line with other printing already taking place commercially, such as that with fruit and vegetable packs.

It has also been found that increasing the viscosity in this manner surprisingly does not detrimentally increase the thickness of the coating composition covering the particulate material, thereby ensuring that the interaction between the particulate material and the VOCs is not adversely affected.

The binder may be a water-based binder, preferably a water-based polymeric dispersion. The binder acts to adhere the coating to the substrate. The water-based binder may comprise less than 15 wt. % of an organic solvent, preferably less than 5 wt. % and most preferably less than 1 wt. %. The binder may comprise acrylic and acrylic acid polymers and co-polymers, acrylates, urethanes, urethane acrylates, styrene butadiene rubbers, cyclised rubbers and mixtures thereof.

When the coating composition is applied to a base layer, preferably by printing, the binder provides anchorage of the particulate component to the base layer. The majority of the polymeric materials in the coating composition by dry weight may be the binder. The binder may comprise more than 80% by dry weight of the polymeric component of the coating composition, preferably more than 90% by dry weight of the coating composition and more preferably more than 95% by dry weight of the polymeric component of the coating composition. The “polymeric component of the coating composition” refers to the entire coating composition excluding the particulate component.

The use of a water-based binder, particularly a water-based polymeric dispersion, provides an entirely or substantially water-insoluble coating upon drying. Thus, the particulate components cannot be removed from the dried coating composition by contact with water.

The rheology modifier acts to change the viscosity of the composition and may be a water-soluble compound, preferably a water-soluble polymer. The rheology modifier may comprise water-soluble polymers such as PVOH, polyacrylic acid, PVP, cellulose derivatives such as carboxymethylcellulose (CMC), hydroxypropylcellulose (HPC) and hydroxypropylmethycellulose (HPMC) and mixtures thereof.

The use of a water-soluble rheology modifier maintains the clarity and smoothness of the coating formed from the coating composition. Additionally, the binder may not be required to anchor a polymeric water-soluble rheology modifier to a substrate and said rheology modifier may even provide additional anchorage to the particulate component.

The rheology modifier may be present in the coating composition in a lesser amount than the binder by dry weight. A low amount of the rheology modifier is preferably included in the coating composition, such that the dried coating is entirely or substantially insoluble in water, thereby ensuring that the particulate components cannot be removed from the dried coating composition by contact with water. The lowest amount of rheology modifier needed to achieve the desired viscosity is preferably used.

The rheology modifier may comprise less than 5% by dry weight of the polymeric component of the coating composition. Preferably, the rheology modifier comprises less than 3.5% by dry weight of the polymeric component of the coating composition and most preferably, the rheology modifier comprises less than 1% by dry weight of the polymeric component of the coating composition.

The rheology component preferably has a high molecular weight, preferably of 1 MDa and above and more preferably of 1.2 MDa and above. A lower amount of the rheology modifier by weight is therefore required in the coating to sufficiently increase the viscosity, which improves the water insolubility of the dried coating.

The ratio of the binder and the rheology modifier may be such that a specific viscosity of the coating composition is achieved. The viscosity may be tailored to enable optimal application of the coating composition onto a base layer using a desired application method, which may be printing.

The viscosity of the coating composition may be between around 14 seconds to around 50 seconds and preferably between around 20 and around 30 seconds flow time using a Zahn-2 cup. The cup is completely immersed in the ink and withdrawn. The time for the ink to flow through the base hole is measured, as outlined in ASTM 4212.

The ideal viscosity depends on printing speeds, solvent evaporation rate, cell dimensions and depth, substrate type and machine design. A flow time of between 20 and 30 seconds is preferable if the composition is intended for use in flexographic printing.

The binder and the rheology modifier may be free from components that render the particulate component inactive following drying of the coating. Such components include hydrocarbons, particularly aromatic hydrocarbons such as benzene, toluene and xylene, ketones such as acetone, methyl ethyl ketone and cyclohexanone, esters such as ethyl acetate, propyl acetate, butyl acetate, isobutyl acetate and amyl acetate, ethers such as diethyl ether, isopropyl ether and tetrahydrofuran, alcohols such as methanol, ethanol, propan-1-ol, propan-2-ol, butan-1-ol and butan-2-ol, polyhydric alcohols such as ethylene glycol and propylene glycol, amines such as ammonia, trimethylamine and trimethylamine, metal salts, metal hydroxides, sulphides, sulphates or other sulphur based compounds.

The selection of certain binders and rheology modifiers is important to ensure that the particulate component is not poisoned by any components of the coating composition. The rheology modifier preferably is compatible with and does not destabilise the binder, which can cause the binder to fall out thereby reducing the processability of the coating composition. The compounds listed above and combinations thereof are suitable for use in the present invention.

The rheology modifier may be a non-ionic water-soluble polymer. Suitable non-ionic water-soluble polymers include PVOH, PVP, cellulose derivatives such as hydroxypropylcellulose (HPC) and hydroxypropylmethycellulose (HPMC) and mixtures thereof. These rheology modifiers are less likely to destabilise the binder dispersion.

The binder may be a water-based polyurethane and the rheology modifier may be hydroxypropylmethyl cellulose. The hydroxypropylmethyl cellulose may be present in an amount of less than 1 wt. %.

The term “volatile organic compound” is used herein to refer to an organic chemical having a high vapour pressure at ordinary room temperature, which can be released from organic matter. The volatile organic compound may comprise ethylene or acetaldehyde. Ethylene is responsible for the ripening of a variety of organic materials. Its removal from a packaging structure can therefore increase the shelf life of the organic material.

The volatile organic compound may comprise other plant growth regulators such as: Gibberellins (GA), for example GA4GA7 and GA3; Cytokinins, such as CPPU and kinetin; Auxins, such as 1-naphthalenacetic acid (NAA), 2,4-D, 3-indoleacetaldehyde acid (IAld), 3-indoleacetic acid (IAA), 3-indolepyruvic acid (IPA) and indolebutanoic acid (IBA); and Inhibitors/Retardants, such as abscisic acid (ABA), ancymidolm, carbaryl, chlormequat, chloro IPC, daminozide, flurprimidol, hydrogen cyanamide (H2CN2), mefluidide, mepiquat chloride, paclobutrozol, prohexadione calcium, and succinic acid (SADH). The particulate component may remove more than one volatile organic compound.

The particulate component may be able to remove the volatile organic compound from the environment in contact with the coating composition via any effective means such as adsorption, absorption or chemical modification.

The particulate component able to remove ethylene from the environment in contact with the coating composition may comprise any material disclosed in WO2016181132.

The particulate component may be a sorbent. The sorbent may be a microporous material such as a zeolite, sepiolite or diatomite, which may be ZSM5, or a clay. The zeolite or other microporous material may be doped, for example with a metal such as palladium. Palladium doped zeolites are particularly contemplated, as described in WO2011/001186. Sorbents, specifically zeolite sorbents, are well known in the art for use in the removal of ethylene from an environment. They are readily available and their chemistry is well known.

The particulate component may have an average particle size of between 1 and 10 microns in diameter, preferably between 3 and 7 microns in diameter. Sedimentation is particularly problematic with such particulate components if no rheology modifier is present in the coating composition.

According to a second aspect of the present invention, there is provided a substrate for use in or as a packaging structure comprising a base layer and a coating formed from the coating composition discussed above. The coating may have been printed onto the base layer.

The base layer may be any suitable supporting material. The base layer may be a polymeric material, a plastics material, pulp-based materials such as paper, card, cardboard and board, non-woven materials, wood or metal. The base layer may comprise a film or another sheet material, a laminate and/or a composite. The film may be metallised or coated with a metal oxide. The base layer may be stiff or flexible.

The substrate may comprise a plurality of layers of the coating composition. The layers may be positioned on top of one another.

One or more layers of the substrate may comprise one or more functional materials for other purposes in relation to the functional or aesthetic characteristics of the substrate. Suitable functional materials may be selected from one or more of the following, mixtures thereof and/or combinations thereof: UV absorbers, dyes, pigments, colorants, metallised and/or pseudo-metallised coatings, lubricants, anti-static agents (cationic, anionic and/or non-ionic, e.g. poly-(oxyethylene) sorbitan monooleate), anti-oxidants (e.g. phosphorous acid, tris(2,4-di-tert-butyl phenyl) ester), surface-active agents, stiffening aids, slip aids (for example hot slips aids or cold slip aids which improve the ability of a coating to slide satisfactorily across surfaces at about room temperature, e.g. micro-crystalline wax), gloss improvers, prodegradants, barrier coatings to alter the gas and/or moisture permeability properties of the film (such as polyvinylidene halides, e.g. PVdC), anti-blocking aids (for example microcrystalline wax, e.g. with an average particle size from about 0.1 to about 0.6 μm), tack reducing additives (e.g. fumed silica, silica, silicone gum), particulate materials (e.g. talc), plasticisers, additives to increase coefficient of friction (e.g. silicon carbide), additives to remove malodorous materials from the surrounding environment, additives to improve ink adhesion and/or printability, additives to increase stiffness (e.g. hydrocarbon resin), additives to increase shrinkage (e.g. hard resins), antimicrobials, antimist additives, release coatings and volatile organic compound blockers. One or more of these components may also be present in the coating composition described above.

The substrate may further comprise one or more functional barrier layers. The functional barrier layer may be present as a topcoat. Additionally or alternatively, the functional barrier layer may be present between the coating and the base layer. If the substrate comprises functional barrier layers both as a topcoat and between the coating and the base layer, the functional barrier layers may be the same or different.

The one or more functional barrier layers may act to limit migration of a functional part of the particulate component. The one or more layers may also protect the particulate component from dusting and/or dislodging due to abrasion, flexing or the like. The one or more functional barrier layers may also protect the particulate component from water, which may be particularly important if parts of the particulate component are exposed. This may also be particularly important if the particulate component is a zeolite, as these components can be poisoned or otherwise compromised by contact with water.

The functional barrier layer may impart the surface of the substrate with additional beneficial properties, such as receptivity to inks and adhesives, improved optics, improved coefficient of friction or improved blocking characteristics. This is particularly the case if the functional barrier layer is a topcoat.

The functional barrier layer may separate the particulate component from the contents of the packaging, particularly if said contents comprises food. This may be necessary to comply with regulatory requirements.

The presence of a functional barrier layer between the coating and the base layer may be particularly important if the base layer has an open structure and/or is permeable. The presence of a functional barrier between the coating and the base layer can prevent migration of parts of the particulate component through the substrate, which can result in said parts escaping the substrate and contacting the contents of the packaging, which may comprise food.

The presence of a functional barrier layer between the coating and the base layer may reduce or prevent wicking of water or the binder into the base layer. This is particularly problematic when the base layer has an open structure and/or is absorbent, such as Tyvek, cardboard, paper or non-woven materials. The wicking of water or binder into the base layer may result in insufficient binder being present in the coating to anchor the particulate component to the substrate.

The functional barrier layer between the coating and the base layer may also provide anchorage of the coating composition to the base layer.

The one or more functional barrier layers may comprise a rheology modifier, which increases the viscosity of the layer. The rheology modifier may have any of the features discussed above. The one or more functional barrier layers may comprise a binder having any of the features discussed above. The one or more functional barrier layers may be the same as the coating composition, but without the particulate component. The functional barrier may be applied using a printing method.

The inclusion of a rheology modifier in the functional barrier layer between the coating and the base layer helps to further reduce the wicking of water or binder into the base layer. The amount of wicking can be controlled by altering the viscosity of the functional barrier layer using a rheology modifier.

The functional barrier layer may be sufficiently permeable to volatile organic compounds to enable the volatile organic compounds present in the environment surrounding the substrate to interact with the particulate component.

According to a third aspect of the present invention, there is provided a packaging structure comprising the substrate as discussed above.

The substrate may form a cover layer or a base layer of the packaging structure. The substrate may also be able to at least partially surround or envelop an item to be packaged in the packaging structure. Additionally or alternatively, the substrate may be at least partially laminated to a bubble wrap layer or a moisture absorbent pad. This can act to protect the contents of the packaging structure from damage. The substrate may also form part of a transit liner or a bag, or may be laminated to another substrate such as a thermoformable film, sheet or tray.

The environment in contact with the substrate may be an atmospheric environment into which at least one volatile organic compound is emitted from organic matter contained within the packaging structure. Both modified and unmodified atmosphere packaging structures are specifically contemplated. The modified atmosphere packaging may allow the creation of a reduced oxygen, elevated carbon dioxide and/or elevated humidity environment in contact with the substrate. The modified atmosphere packaging may be active or passive in that the environment within the packaging may result solely from the presence of the product therein or may be artificially enhanced.

The combination of a modified atmosphere packaging with a particulate compound capable of removing a VOC from an environment can further extend the life of fresh produce and can demonstrate synergistic results.

The substrate may be used in combination with other active packaging systems, such as moisture control systems, antimicrobial systems and/or volatile organic compound blockers.

According to a fourth aspect of the present invention, there is provided a package comprising an item capable of emitting a volatile organic compound that is at least partially enveloped or surrounded by the packaging structure discussed above. The item may be a comestible or horticultural item.

According to a fifth aspect of the present invention, there is provided a method of producing the substrate as discussed above comprising applying the coating composition as discussed above onto the base layer.

The coating may be printed using a flexographic or screen printing process, or any other suitable printing process.

The coating may alternatively be applied using a coating method. The coating method may be flood coating, such as an aqueous flood coating applied by gravure or reverse gravure, slot die coating, extrusion coating or any other coating technique.

The method may comprise the sequential application of multiple layers of the coating composition. This can improve the loading of the particulate component, thereby increasing the level of the particulate component per unit of area of the substrate.

The coating composition may be directly applied to the base layer. The base layer may contain an intermediate layer, for example a metal or metal oxide layer, onto which the coating composition may be applied. This is still to be construed as applying the coating composition to the base layer. The method may further comprise the step of applying a functional barrier layer to the base layer and applying the coating onto the functional barrier layer.

The method may further comprise the step of applying a functional barrier layer to the surface of the coating, once it has been applied to the base layer or another functional barrier layer.

The coating composition and the one or more functional barrier layers may be applied to the base layer in-line, as part of the same coating or printing process. The coating composition and the one or more functional barrier layers may be applied in separate steps. Each of the separate steps may utilise the same or different coating or printing methods.

The coating composition and the one or more functional barrier layers may be applied to the base layer in-line, as part of the same coating or printing process. The coating composition and the one or more functional barrier layers may be applied in separate steps. Each of the separate steps may utilise the same or different coating or printing methods.

The substrate 1 further comprises two functional barrier layers, 5a and 5b. Functional barrier layer 5a is a topcoat that covers the binder and rheology modifier 3 and the particulate component 4. This barrier layer 5a protects the particulate component 4 from dusting and dislodging, as well as contact with water. Functional barrier layer 5a also prevents parts of the particulate component 4 from being released from the substrate 1.

Functional barrier layer 5b is positioned between the base layer 2 and the binder and rheology modifier 3. This barrier layer prevents water and binder from wicking into the base layer 2. This would reduce the amount of binder available to anchor the particulate component 4 to the substrate 1.

1. A coating composition comprising a binder, a rheology modifier that acts to increase the viscosity of the coating composition and a particulate component able to remove a volatile organic compound from an environment in contact with the coating composition.

2. The coating composition according to claim 1, wherein the binder comprises acrylic and acrylic acid polymers and co-polymers, acrylates, urethanes, urethane acrylates, styrene butadiene rubbers, cyclised rubbers and mixtures thereof.

3. The coating composition according to claim 1, wherein the rheology modifier comprises water-soluble polymers such as PVOH, polyacrylic acid, PVP, cellulose derivatives such as carboxymethylcellulose (CMC), hydroxypropylcellulose (HPC) and hydroxypropylmethycellulose (HPMC) and mixtures thereof.

4. The coating composition according to claim 3, wherein the rheology modifier comprises non-ionic water-soluble polymers such as PVOH, PVP, cellulose derivatives such as hydroxypropylcellulose (HPC) and hydroxypropylmethycellulose (HPMC) and mixtures thereof.

5. The coating composition according to claim 1, wherein the binder is a water-based polymeric dispersion and the rheology modifier is a water-soluble polymer.

6. The coating composition according to claim 1, wherein the rheology modifier comprises less than 5% by dry weight of the polymers present in the coating composition.

7. The coating composition according to claim 1, wherein the rheology modifier has a molecular weight of more than 1 MDa.

8. A substrate for use in or as a packaging structure comprising a base layer and a coating formed from the coating composition of claim 1.

9. The substrate according to claim 8, wherein the base layer comprises a polymeric material, a plastics material, pulp-based materials such as paper, card, cardboard and board, non-woven materials, wood or metal.

10. The substrate according to claim 8, further comprising a functional barrier layer between the coating and the base layer.

11. The substrate according to claim 10, wherein the functional barrier layer comprises a rheology modifier.

12. A packaging structure comprising the substrate of claim 8.

13. The packaging structure of claim 12, further comprising one or more active packaging systems, such as moisture control systems, antimicrobial systems and/or volatile organic compound blockers.

14. The packaging structure of claim 12, wherein the packaging structure is an active or passive modified atmosphere packaging.

15. A package comprising an item capable of emitting a volatile organic compound at least partially enveloped or surrounded by the packaging structure of claim 12.

16. A method of producing a substrate for use in or as a packaging structure, wherein the substrate comprises a base layer and a coating, said method comprising the step of
applying the coating composition according to claim 1 onto the base layer.

17. The method according to claim 16, wherein the coating composition is applied using flexographic or screen printing.

18. The method according to claim 16, wherein a plurality of layers of coating composition are sequentially applied onto the base layer.

19. The method according to claim 16, further comprising the step of applying a functional barrier layer to the base layer before applying the coating composition thereto.
